(19) United States
(12) Patent Application Publication
(10) Pub. No.: US 2008/0267362 A1
(43) Pub. Date: Oct. 30, 2008

(54) SELECTING A REMOTE SESSION AUDIO STREAM SENT TO A RECEIVING STATION FROM ONE OF A PLURALITY OF SENDING STATIONS

(76) Inventors: Derek J. Lukasik, Fort Collins, CO (US); Roland M. Hochmuth, Fort Collins, CO (US); Roy L. Troutman, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/742,477

(22) Filed: Apr. 30, 2007

(51) Int. Cl. H04M 1/64

(52) U.S. Cl. 379/67.1

(57) ABSTRACT

Methods and systems for selecting a remote session audio stream sent to a receiving station from one of a plurality of sending stations are described herein. At least some illustrative embodiments comprise a method that comprises receiving a message comprising audio data at a receiving station (the audio data representing at least part of an audio stream associated with a first remote session established between the receiving station and a first sending station of a plurality of sending stations), and selecting the audio stream and presenting the audio data as audio to a user of the receiving station if the audio stream is enabled.

### BACKGROUND

With the proliferation of high speed networks and Internet access, an increasing number of corporate entities now provide their employees with remote access to corporate computers. This allows employees to work from home or other locations during normal working hours (sometimes referred to as telecommuting), as well as after-hours and on weekends. Such remote access to computer resources is provided by a variety of software packages, such as, for example, Remote Desktop Client interacting with Terminal Services, both by Microsoft®. These and other similar software packages can provide access to a collection of terminal sessions and virtual computers selected from a pool, or access to specific individual computers. Users log into a “remote session” wherein the user's desktop appears as the desktop would appear if the user were logged in locally to an actual, distinct computer.

At least some remote access software programs allow a single user workstation to establish remote sessions with multiple remote computers. In such systems, the client side of the remote access program relies on the underlying windowing environment to control and re-direct the flow of inputs provided by the user to the remote computer, as well as the presentation of graphical displays and audio presented by the remote computer to the user. In such windowing environments, input is directed to a particular remote session window based on which window has the “focus,” i.e., which window is selected by the user, either in windowed or full-screen mode. But only input from the user is re-directed based on the current focus. Graphical displays are presented regardless of focus as long as the corresponding window is not minimized or hidden/occluded by another window. Audio is presented unconditionally, regardless of focus or the state of the window (i.e., minimized, restored or maximized). The parallel presentation of graphical displays in multiple windows does not generally create difficulties for the user, as a user can choose to look at or ignore individual windows. But this is not the case with multiple audio streams, since the user cannot simply listen to one audio stream when it is overlayed with one or more additional audio streams, all concurrently being presented to the user.

### BRIEF DESCRIPTION OF THE DRAWINGS

For a detailed description of exemplary embodiments of the invention, reference will now be made to the accompanying drawings in which:

FIG. 1 shows a system comprising a receiving station and a sending station, configured to operate in accordance with at least some illustrative embodiments;

FIG. 2A shows an example of a system configuration, suitable for use as either the receiving station or the sending station of FIG. 1, in accordance with at least some illustrative embodiments;

FIG. 2B shows a block diagram of the system configuration of FIG. 2A, in accordance with at least some illustrative embodiments;

FIG. 3 shows a system comprising a receiving station and multiple sending stations, configured to operate in accordance with at least some illustrative embodiments;

FIG. 4 shows a method for selecting audio streams associated with multiple remote sessions, in accordance with at least some illustrative embodiments;

FIG. 5 shows a method for configuring how audio streams associated with multiple remote session are selected, in accordance with at least some illustrative embodiments; and

FIG. 6 shows a method for dynamically selecting and deselecting audio streams associated with multiple remote sessions, in accordance with at least some illustrative embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. Additionally, the term “system” refers to a collection of two or more hardware and/or software components, and may be used to refer to an electronic device, such as a computer, a portion of a computer, a combination of computers, etc. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

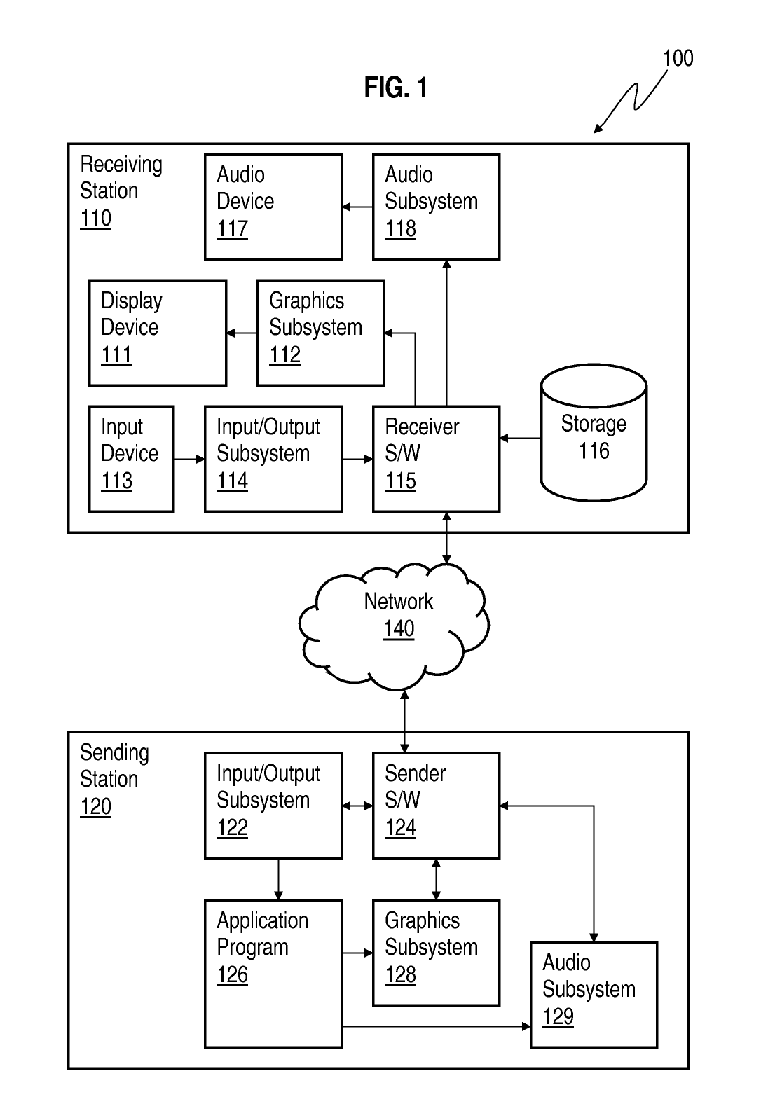

FIG. 1 shows a computer system 100, in accordance with at least some illustrative embodiments, in which a receiving station 110 interacts with a sending station 120. Receiving station 110 and sending station 120 couple to each other via a network 140, such as, for example, the Internet. Receiving station 110 comprises logic that provides some or all of the functionality of receiving station 110. The logic of receiving station 110 may comprise software executing on a processor (e.g., receiver software (Receiver S/W) 115 as shown in FIG. 1), dedicated or programmable digital hardware, or a combination of both software and hardware.

Receiving station 110 also comprises graphics subsystem 112 and display device 111, which provide graphical images to a user of receiving station 110; input/output subsystem 114 and input device 113 which receive input data from the user; audio subsystem 118 and audio device 117 which provide audio to the user of receiving station 110; and storage device 116, which may be used to store at least some configuration information used by receiver software 115. Receiver software 115 receives messages from sending station 120. The messages comprise video data that is forwarded to graphics subsystem 112, which displays the information to the user via display device 111, as well as audio data that is forwarded to audio subsystem 118 for presentation to the user via audio device 117. The user provides input via input device 113, which is forwarded by input/output subsystem 114 to receiver software 115. Receiver software 115 subsequently sends one or more messages to sending station 120 comprising the input data received from input/output subsystem 114. The input data comprises data that originates from input device 113, which in at least some illustrative embodiments includes a keyboard and mouse.

Continuing to refer to the illustrative embodiment of FIG. 1, sending station 120 comprises sender software (Sender S/W) 124 and application program 126, each comprising executable code executing on sending station 120. Sender software 124 provides some or all of the functionality of sending station 120. Sending station 120 also comprises input/output subsystem 122 and graphics subsystem 128. Sender software 124 receives messages from receiving station 110 with input data originated by the user operating receiving station 110 (via input device 113). The input data is forwarded to application program 126 via input/output subsystem 122. Graphical and audio data generated by application program 126 are respectively sent to graphics subsystem 128 and audio subsystem 129, which each respectively forward the graphical and audio data to sender software 124. Sender software formats the graphical and audio data into messages that are transmitted to receiving station 110, which displays the graphical data to the user as previously described, and presents the audio to the user via audio devices such as speakers or headphones.

Sender software 124 and receiver software 115 together act as an abstraction layer that hides the existence of the underlying network from both the user operating receiver station 110 and application program 126 executing on sending station 120. By hiding the underlying network, the user interacts with application 126 as if it were executing locally on receiving station 110, and application 126 interacts with the user as if the user were directly operating sending station 120 via locally-coupled devices. This infrastructure allows for the creation of one or more “remote sessions,” also sometimes referred to as “remote access sessions,” “remote desktop sessions,” “remote visualization sessions,” and “remote graphics sessions.” A remote session is a process by which two computers, a receiving station that initiates the session and a sending station that hosts the session, interact to provide a user at the receiving station with a computing environment that appears to the user as if the user were logged directly into the sending station.

The host sending station provides graphical information to the receiving station within one or more remote session messages, which displays the images represented by the information as the images would be displayed at the sending station if the user were logged-in locally to the sending station. The graphical information comprises sequential bits of data, grouped to represent pixels displayed on a display. The data is transmitted in the time-sequenced order in which the pixels are drawn on a display (e.g., left to right for each pixel within a scan line, and top to bottom for each scan line in sequence). Audio information is also transmitted in digital form within one or more remote session messages, with groupings of bits representing encoded audio that is decoded and presented as analog audio to the user as if the user were logged-in locally to the sending station. Likewise, the user operates the receiving station, which provides input data (e.g., keyboard characters and mouse coordinate data) to the sending station, and the input data is received and processed by the sending station in the same manner as inputs provided by a locally logged-in user.

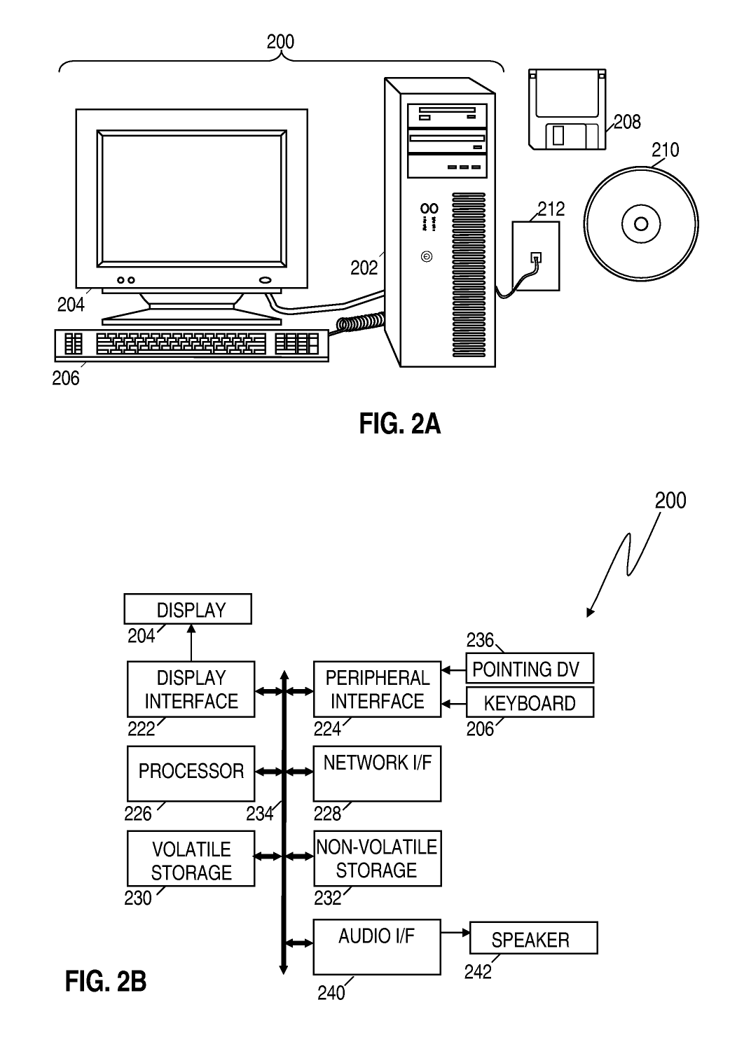

FIGS. 2A and 2B show an illustrative system configuration 200 suitable for implementing receiving station 110 and sending station 120 of FIG. 1. As shown, the illustrative system configuration 200 comprises a chassis 202, a display 204, and an input device 206. The system configuration 200 comprises a processor 226, volatile storage 230, and non-volatile storage 232. Volatile storage 230 comprises a computer-readable medium such as random access memory (RAM). Non-volatile storage 232 comprises a computer-readable medium such as flash RAM, read-only memory (ROM), a hard disk drive, a compact disk read-only memory (CD-ROM), and combinations thereof.

The computer-readable media of both volatile storage 230 and non-volatile storage 232 comprise, for example, software that is executed by processor 226 and provides both receiving station 110 and sending station 120 with some or all of the functionality described herein. The system configuration 200 also comprises a network interface (Network I/F) 228 that enables the system configuration 200 to receive information via a local area network and/or a wired or wireless wide area network, represented in the example of FIG. 2A by Ethernet jack 212. A display interface 222 couples to the display 204. A user interacts with the station via the input device 206 and/or pointing device 236 (e.g., a mouse), which couples to a peripheral interface 224. The display 204, together with the input device 236 and/or the pointing device, may operate together as a user interface.

System 200 may be a bus-based computer, with the bus 234 interconnecting the various elements shown in FIG. 2B. The peripheral interface 224 accepts signals from the keyboard 206 and other input devices such as a pointing device 236, and transforms the signals into a form suitable for communication on the bus 234. The display interface 222 may comprise a video card or other suitable display interface that accepts information from the bus 234 and transforms it into a form suitable for the display 204. The audio interface 240 may comprise a sound card or other suitable audio interface that accepts information from the bus 234 and transforms it into a form suitable for driving the speaker 242.

The processor 226 gathers information from other system elements, including input data from the peripheral interface 224, and program instructions and other data from non-volatile storage 232 or volatile storage 230, or from other systems (e.g., a server used to store and distribute copies of executable code) coupled to a local area network or a wide area network via the network interface 228. The processor 226 executes the program instructions and processes the data accordingly. The program instructions may further configure the processor 226 to send data to other system elements, such as information presented to the user via the display interface 222 and the display 204, and audio presented to the user via the audio interface 240 and the speaker 242. The network interface 228 enables the processor 226 to communicate with other systems via a network (e.g., network 140 of FIG. 1). Volatile storage 230 may serve as a low-latency temporary store of information for the processor 226, and non-volatile storage 232 may serve as a long term (but higher latency) store of information.

The processor 226, and hence the system configuration 200 as a whole, operates in accordance with one or more programs stored on non-volatile storage 232 or received via the network interface 228. The processor 226 may copy portions of the programs into volatile storage 230 for faster access, and may switch between programs or carry out additional programs in response to user actuation of the input device. The additional programs may be retrieved from non-volatile storage 232 or may be retrieved or received from other locations via the network interface 228. One or more of these programs executes on system configuration 200 causing the configuration to perform at least some of the receiving and sending functions of receiving station 110 and sending station 120, respectively, as disclosed herein.

Although a fully equipped computer system is shown in the illustrative embodiment of FIGS. 2A and 2B, other embodiments comprise fewer options and may be suitable as the receiving station 110. At least some embodiments of receiving station 110 comprise only some of the hardware features shown in FIGS. 2A and 2B, and only execute the software necessary to establish a remote session. Such embodiments of the receiving station 110 are referred to as a “thin” client. Similarly, at least some embodiments of sending station 120 comprise only some of the hardware features shown in FIGS. 2A and 2B. For example, if sending station 120 is used exclusively as a remote host, keyboard 206, pointing device 236, speaker 242 and display 204 are not needed. Other embodiments of the receiving and sending stations, with various combinations of hardware features and installed software, will become apparent to those skilled in the art, and all such embodiments of the receiving and sending stations are intended to be within the scope of the present disclosure.

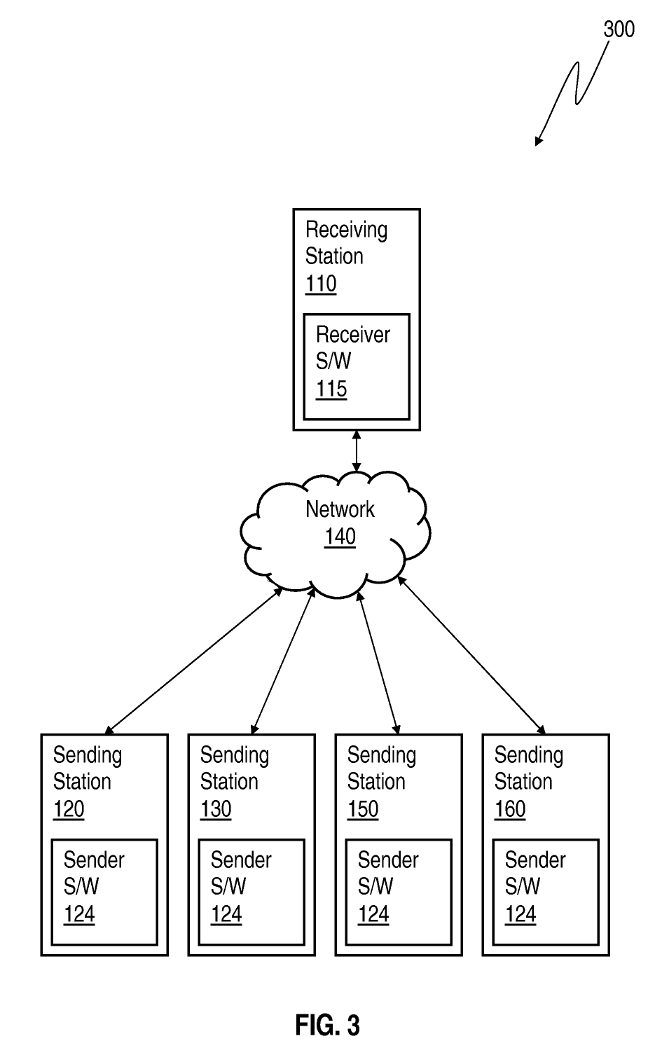

In at least some illustrative embodiments, receiver software 115 is capable of establishing multiple remote sessions, each with a separate sending station. FIG. 3 shows a system 300 comprising a single receiving station 110 executing an instance of receiver software 115 and coupled to a network 140. Four sending stations (120, 130, 150 and 160) also couple to network 140, each sending station executing an instance of sender software 124. Receiving station 110 and receiver software 115 interact with each of the sending stations (120, 130, 150 and 160) as described above with regard to receiving station 110 and sending station 120 of FIG. 1.

In at least some illustrative embodiments, the receiver software executes within a windowed operating system (e.g., Microsoft® Windows®), which allows a user operating the receiving station to control each session from a separate window. The user switches between sessions using the mechanisms provided by the operating system (e.g., clicking on a window using a mouse, or using an ALT-TAB shortcut key sequence). The receiver software 115 tracks which window, and thus which session, has been selected. This selection is sometimes referred to as the “window focus.” In a windowed operating system, inputs provided by the user (e.g., via the keyboard and mouse) are directed by the operating system to the window that has the window focus. Based on which window is selected and thus has the window focus, receiver software 115 decodes the audio data received from the sending station corresponding to the selected session and presents it to the user using the receiving station 110's audio software and hardware. In this manner, a user operating the receiving station 110 only hears audio streams associated with the session selected by the user. The receiver software 115 thus dynamically selects the audio stream matching the window/session that currently has the window focus.

In other illustrative embodiments, the user can choose between a dynamic selection of audio streams, as described above, and a static selection. If the user chooses a static selection, the receiver software 115 presents the audio streams corresponding to a list of selected sessions, regardless of the session selected (i.e., regardless of the window focus). A user selects which sessions are selected via a selection window, wherein the user enables the audio streams by selecting one or more checkboxes corresponding to sessions displayed in a list of sessions. The selection of a session causes the session to be added to the list of selected sessions. As audio stream data is sent to receiving station 110, receiver software 115 only forwards audio data for presentation to the user that corresponds to sessions that are on the list of selected sessions. In at least some illustrative embodiments, if only one remote session is active then the audio stream for the one remote session is always active, regardless of whether receiver software is configured for dynamic or static audio stream selection, and regardless of which window is selected.

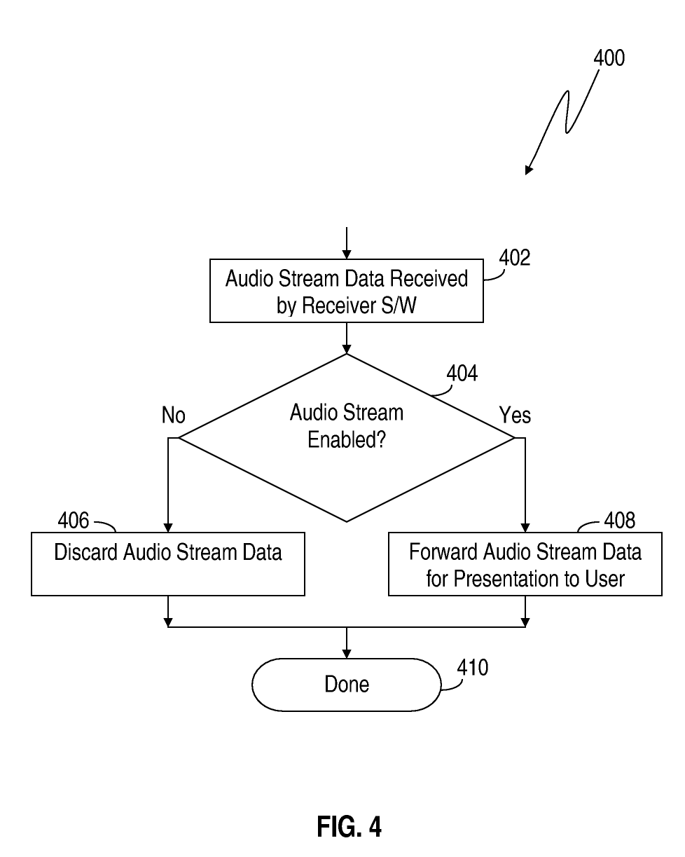

FIG. 4 shows a method 400 for selecting one or more audio streams, each associated with a different remote session, in accordance with at least some illustrative embodiments. Referring to FIGS. 1, 3 and 4, receiving station 110 receives a message (block 402) comprising audio data associated with a particular remote session that is active between receiving station 110 and a sending station (e.g., sending station 160). Receiver software 115, upon receiving the message, determines whether the audio stream associated with the particular remote session is currently enabled (block 404), i.e., whether the audio stream is either dynamically selected or statically configured by the user to be heard at the receiving station 110. If the audio stream is enabled, the audio data is forwarded to audio subsystem 118 for decoding and presentation to the user via audio device 117 (block 408), completing the method 400 (block 410). If the audio stream is not enabled, the audio data is not presented to the user (e.g., discarded or ignored) and thus not heard by the user of receiving station 110, completing the method 400 (block 41).

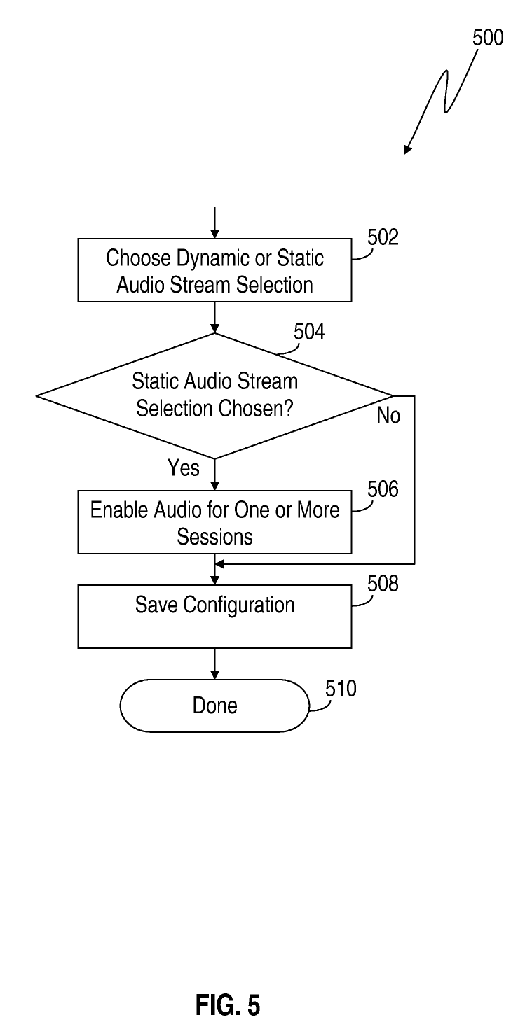

FIG. 5 shows a method 500 for configuring how audio streams associated with multiple sessions are selected by receiver software 115, in accordance with at least some illustrative embodiments. Referring to FIGS. 1, 3 and 5, a user operating receiving station 110 places receiver software 115 into a configuration mode (e.g., by selecting a configuration option from a drop down menu within a remote session window). While in the configuration mode, the users first chooses whether receiver software 115 will select audio streams dynamically (i.e., based upon the session window selected), or statically (i.e., based upon a fixed list of sessions to be heard), as shown in block 502.

If the user chooses static selection (block 504), the user is presented with a list of remote sessions currently active on receiving station 110. The user selects from the list (e.g., by selecting checkboxes associated with each listed session) which audio streams are to be enabled and presented to the user (block 506). The selection configuration is then saved (block 508) for subsequent use by the audio stream selection method (e.g., method 400), completing the method 500 (block 510). In at least some illustrative embodiments, the configuration is saved on a non-volatile storage device, such as storage 116 of FIG. 1. If the user does not choose static selection, instead choosing dynamic selection (block 504), no further configuration is necessary and the configuration is saved (block 508), completing the method 500 (block 510).

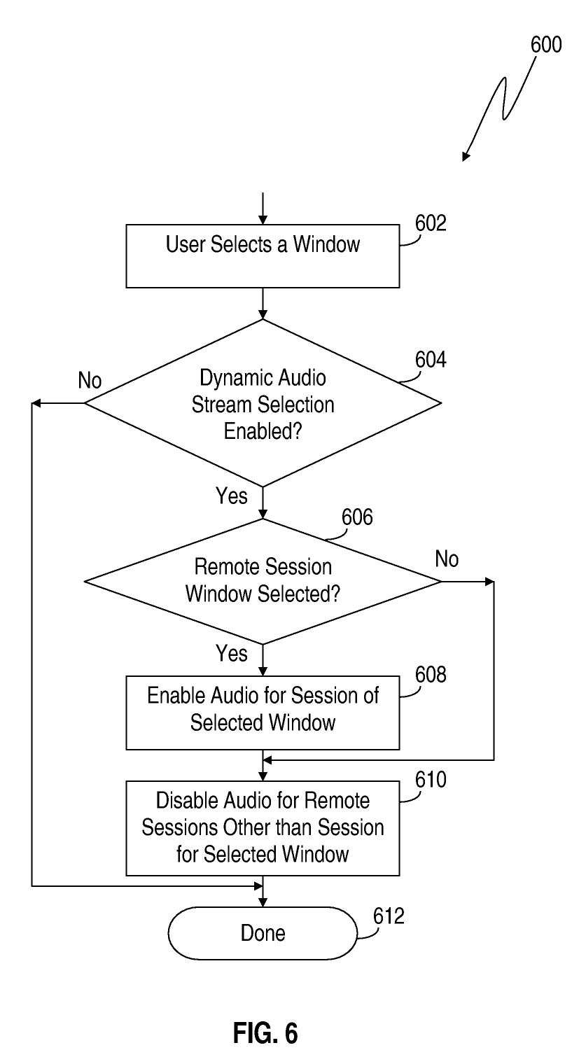

FIG. 6 shows a method 600 for dynamically selecting and deselecting audio streams associated with multiple remote sessions, in accordance with at least some illustrative embodiments. Referring to FIGS. 1, 3 and 6, method 600 begins in response to a user selecting a window (block 602), such as by clicking on the window using a mouse or selecting a window using a keyboard shortcut (e.g., ALT-TAB). Method 600 may be configured to execute, for example, by implementing it as an event handler within a windowing system executing on receiving station 110 (e.g., Microsoft® Windows®) that executes whenever the window focus changes.

If receiver software 115 is configured for dynamic audio stream selection (block 604) and a remote session window is selected (block 606), then the audio stream associated with the remote session of the selected window is enabled (block 608), and the audio streams of all other active remote sessions are disabled (block 610), completing the method 600 (block 612). If receiver software 115 is configured for dynamic audio stream selection (block 604) but the window selected is not associated with a remote session (block 606), then the audio streams of all other active remote sessions are disable (block 610), which results in all audio streams associated with remotes session being disabled, completing the method 600 (block 612). If receiver software 115 is not configured for dynamic audio stream selection (block 604), no action is taken, completing the method 600 (block 612).

The above discussion is meant to be illustrative of the principles and various embodiments of the present invention. Numerous variations and modifications will become apparent to those skilled in the art once the above disclosure is fully appreciated. For example, although the illustrative embodiments of the present disclosure describe software implementations of the methods described, other illustrative embodiments include hardware implementations, as well as combinations of hardware and software implementations. It is intended that the following claims be interpreted to embrace all such variations and modifications.

What is claimed is:

1. A method, comprising:
receiving a message comprising audio data at a receiving station, the audio data representing at least part of an audio stream associated with a first remote session established between the receiving station and a first sending station of a plurality of sending stations; and
selecting the audio stream and presenting the audio data as audio to a user of the receiving station if the audio stream is enabled.

2. The method of claim 1, further comprising not presenting the audio data as audio to the user if the audio stream is not enabled.

3. The method of claim 1, further comprising:
enabling selection of the audio stream based upon which of a plurality of windows within a windowing system is selected;
the user selecting a window of the plurality of windows corresponding to the first remote session; and
enabling the audio stream in response to the user selecting the window.

4. The method of claim 3, further comprising disabling audio streams associated with any additional remote sessions in response to the user selecting the window, the additional remote session established between the receiving station and additional sending stations of the plurality of sending stations.

5. The method of claim 1, further comprising:
enabling selection of the audio stream based upon which of a plurality of windows within a windowing system is selected;
the user selecting a window of the plurality of windows that does not correspond to a remote session; and
disabling all audio streams associated with remote sessions active on the receiving station in response to the user selecting the window.

6. The method of claim 1, further comprising:
enabling selection of the audio stream based upon whether a remote session list comprises the first remote session associated with the audio stream;
the user adding the first remote session to the remote session list;
enabling the audio stream in response to the user adding the first remote session to the remote session list.

7. The method of claim 6, wherein presenting the audio data further comprises determining that the audio stream is enabled if the first remote session is on the remote session list.

8. The method of claim 1, further comprising enabling the audio stream if no more than one remote session is established.

9. A system, comprising
a network interface configured to receive audio data from at least one sending station; and
logic that processes the audio data;
wherein the system transmits and receives messages as part of a remote session comprising an audio stream that comprises the audio data; and
wherein the logic selects the audio stream and presents the audio data as audio to a user of the system if the audio stream is enabled.

10. The system of claim 9,
wherein the logic enables selection of the audio stream based upon which of a plurality of windows within a windowing system is selected; and
wherein the logic enables the audio stream in response to a user selection of a window of the plurality of windows.

11. The system of claim 10, wherein the logic disables audio streams associated with any additional remote sessions established with the system, the audio streams disabled in response to the user selection of the window.

12. The system of claim 9,
wherein the logic enables selection of the audio stream based upon whether a remotes session list comprises the remote session that comprises the audio stream; and
wherein the logic enables the audio stream in response to a user addition of the remote session to the remote session list.

13. A computer-readable medium comprising software that causes a processor to:
receive a message comprising audio data at a receiving station, the audio data representing at least part of an audio stream associated with a first remote session established between the receiving station and a first sending station of a plurality of sending stations; and
select the audio stream and present the audio data as audio to a user of the receiving station if the audio stream is enabled.

14. The computer-readable medium of claim 13, wherein the software further causes the processor to not present the audio data as audio to the user if the audio stream is not enabled.

15. The computer-readable medium of claim 13, wherein the software further causes the processor to:
enable selection of the audio stream based upon which of the plurality of windows within a windowing system is selected;
detect a user selection of a window of the plurality of windows corresponding to the first remote session; and
enable the audio stream in response to the user selection of the window.

16. The computer-readable medium of claim 13, wherein the software further causes the processor to disable audio streams associated with any additional remote sessions in response to the user selecting the window, the additional remote sessions established between the receiving station and additional sending stations of the plurality of sending stations.

17. The computer-readable medium of claim 13, wherein the software further causes the processor to:
enable selection of the audio stream based upon which of a plurality of windows within a windowing system is selected;
detect a user selection of a window of the plurality of windows that does not correspond to a remote session; and
disable all audio streams associated with remote sessions active on the receiving station in response to the user selection of the window.

18. The computer-readable medium of claim 13, wherein the software further causes the processor to:
enable static selection of the audio stream, wherein the audio stream is enabled based upon whether a remote session list comprises the first remote session associated with the audio stream;
detect a user addition of the first remote session to the remote session list;
enable the audio stream in response to the user addition of the first remote session to the remote session list.

19. The computer-readable medium of claim 13, wherein the software further causes the processor to determine that the audio stream is enabled if the first remote session is on the remote session list.

20. The computer-readable medium of claim 13, wherein the software further causes the processor to enable the audio stream if no more than one remote session is established.
